(19) United States
(12) Patent Application Publication
(10) Pub. No.: US 2006/0036579 A1
(43) Pub. Date: Feb. 16, 2006

(54) Apparatus, system, and method for associating resources using a time based algorithm

(76) Inventors: Stephen A. Byrd, San Jose, CA (US); Steven Czerwinski, Berkeley, CA (US); J. Kristofer Fox, San Luis Obispo, CA (US); Bruce Light Hillsberg, San Carlos, CA (US); Bernhard Julius Klingenberg, Morgan Hill, CA (US); Rajesh Francisco Krishnan, San Jose, CA (US); Balaji Thirumalai, Newark, CA (US)

Correspondence Address: KUNZLER & ASSOCIATES, 8 EAST BROADWAY, SUITE 600, SALT LAKE CITY, UT, 84111, US

(21) Appl. No.: 10/915,132

(22) Filed: Aug. 10, 2004

(51) Int. Cl. G06F 17/30

(52) U.S. Cl. 707/3

(57) ABSTRACT

An apparatus, system, and method are provided for associating resources using a time based algorithm. The apparatus comprises an initialization module, a query module, and a resource time module. The initialization module receives a seed identifier that identifies a seed resource. The seed resource may be a data file, an executable file, a directory, or another data structure associated with a logical application or business process. The query module accesses trace data and searches the trace data for a candidate resource that might be linked to the seed resource. The trace data describes a plurality of resource events that occur on a computer or network system. The resource time module selects a candidate resource based on a similar time attribute recorded in the trace data. The similar time attribute may refer to an access time of the candidate resource that is similar to, such as within a time range, an access time of a seed resource or otherwise linked resource. Based on the similar time attribute, the candidate resource may be associated or linked with the seed resource. Together the seed resource and one or more linked resources may form a resource group, which may be associated with a particular logical application or business process.

### BACKGROUND OF THE INVENTION

1. Field of the Invention

The invention relates to data analysis and resource associations. Specifically, the invention relates to apparatus, systems, and methods for associating system resources using an algorithm based on time attributes of the resources.

2. Description of the Related Art

Computer and information technology continues to progress and grow in its capabilities and complexity. In particular, software applications have evolved from single monolithic programs to many hundreds or thousands of object-oriented components that can execute on a single machine or distributed across many computer systems on a network.

Computer software and its associated data is generally stored in persistent storage organized according to some format such as a file. Generally, the file is stored in persistent storage such as a Direct Access Storage Device (DASD, i.e., a number of hard drives). Even large database management systems employ some form of files to store the data and potentially the object code for executing the database management system.

Business owners, executives, managers, administrators, and the like concentrate on providing products and/or services in a cost-effective and efficient manner. These business executives recognize the efficiency and advantages software applications can provide. Consequently, business people factor in the business software applications in long range planning and policy making to ensure that the business remains competitive in the market place.

Instead of concerning themselves with details such as the architecture and files defining a software application, business people are concerned with business processes. Business processes are internal and external services provided by the business. More and more of these business processes are provided at least in part by one or more software applications. One example of a business process is internal communication among employees. Often this business process is implemented largely by an email software application. The email software application may include a plurality of separate executable software components such as clients, a server, a Database Management System (DBMS), and the like.

Generally, business people manage and lead most effectively when they focus on business processes instead of working with confusing and complicated details about how a business process is implemented. Unfortunately, the relationship between a business process policy and its implementation is often undefined, particularly in large corporations. Consequently, the affects of the business policy must be researched and explained so that the burden imposed by the business process policy can be accurately compared against the expected benefit. This may mean that computer systems, files, and services affected by the business policy must be identified.

FIG. 1 illustrates a conventional system 100 for implementing a business process. The business process may be any business process. Examples of business processes that rely heavily on software applications include an automated telephone and/or Internet retail sales system (web storefront), an email system, an inventory control system, an assembly line control system, and the like.

Generally, a business process is simple and clearly defined. Often, however, the business process is implemented using a variety of cooperating software applications comprising various executable files, data files, clients, servers, agents, daemons/services, and the like from a variety of vendors. These software applications are generally distributed across multiple computer platforms.

In the example system 100, an E-commerce website is illustrated with components executing on a client 102, a web server 104, an application server 106, and a DBMS 108. To meet system 100 requirements, developers write a servlet 110 and applet 112 provided by the web server 104, one or more business objects 114 on the application server 106, and one or more database tables 116 in the DBMS 108. These separate software components interact to provide the E-commerce website.

As mentioned above, each software component originates from, or uses, one or more files 118 that store executable object code. Similarly, data files 120 store data used by the software components. The data files 120 may store configuration settings, user data, system data, database rows and columns, or the like.

Together, these files 118, 120 constitute resources required to implement the business process. In addition, resources may include Graphical User Interface (GUI) icons and graphics, static web pages, web services, web servers, general servers, and other resources accessible on other computer systems (networked or independent) using Uniform Resource Locators (URLs) or other addressing methods. Collectively, all of these various resources are required in order to implement all aspects of the business process. As used herein, “resource(s)” refers to all files containing object code or data as well as software modules used by the one or more software applications and components to perform the functions of the business process.

Generally, each of the files 118, 120 is stored on a storage device 122a-c identified by either a physical or virtual device or volume. The files 118, 120 are managed by separate file systems (FS) 124a-c corresponding to each of the platforms 104, 106, 108.

Suppose a business manager wants to implement a business level policy 126 regarding the E-commerce website. The policy 126 may simply state: “Backup the E-commerce site once a week.” Of course, other business level policies may also be implemented with regard to the E-commerce website. For example, a load balancing policy, a software migration policy, a software upgrade policy, and other similar business policies can be defined for the business process at the business process level.

Such business level policies are clear and concise. However, implementing the policies can be very labor intensive, error prone, and difficult. Generally, there are two approaches for implementing the backup policy 126. The first is to backup all the data on each device or volume 122a-c. However, such an approach backs up files unrelated to the particular business process when the device 122a-c is shared among a plurality of business processes. Certain other business policies may require more frequent backups for other files on the volume 122a-c related to other business processes. Consequently, the policies conflict and may result in wasted backup storage space and/or duplicate backup data. In addition, the time required to perform a full copy of the devices 122a-c may interfere with other business processes and unnecessarily prolong the process.

The second approach is to identify which files on the devices 122a-c are used by, affiliated with, or otherwise comprise the business process. Unfortunately, there is not an automatic process for determining what all the resources are that are used by the business process, especially business processes that are distributed across multiple systems. Certain logical rules can be defined to assist in this manual process. But, these rules are often rigid and limited in their ability to accurately identify all the resources. For example, such rules will likely miss references to a file on a remote server by a URL during execution of an infrequent feature of the business process. Alternatively, devices 122a-c may be dedicated to software and data files for a particular process. This approach, however, may result in wasted unused space on the devices 122a-c and may be unworkable in a distributed system.

Generally, a computer system administrator must interpret the business level policy 126 and determine which files 118, 120 must be included to implement the policy 126. The administrator may browse the various file systems 124a-c, consult user manuals, search registry databases, and rely on his/her own experience and knowledge to generate a list of the appropriate files 118, 120.

In FIG. 1, one implementation 128 illustrates the results of this manual, labor-intensive, and tedious process. Such a process is very costly due to the time required not only to create the list originally, but also to continually maintain the list as various software components of the business process are upgraded and modified. In addition, the manual process is susceptible to human error. The administrator may unintentionally omit certain files 118, 120.

The implementation 128 includes both object code files 118 (i.e., e-commerce.exe. Also referred to as executables) and data files 120 (i.e., e-comdata1.db). However, due to the manual nature of the process and storage space concerns, efforts may be concentrated on the data files 120 and data specific resources. The data files 120 may be further limited to strictly critical data files 120 such as database files. Consequently, other important files, such as executables and user configuration and system-specific setting files, may not be included in the implementation 128. Alternatively, user data, such as word processing documents, may also be missed because the data is stored in an unknown or unpredictable location on the devices 122a-c.

Other solutions for grouping resources used by a business process have limitations. One solution is for each software application that is installed to report to a central repository which resources the application uses. However, this places the burden of tracking and listing the resources on the developers who write and maintain the software applications. Again, the developers may accidentally exclude certain files. In addition, such reporting is generally done only during the installation. Consequently, data files created after that time may be stored in unpredictable locations on a device 122a-c.

From the foregoing discussion, it should be apparent that a need exists for an apparatus, system, and method that associates resources with one another using a time based algorithm. Beneficially, such an apparatus, system, and method would search all of the trace data associated with a business process or the entire system and select candidate resources that are anticipated to be related to a seed resource based on a common time attribute. In addition, the apparatus, system, and method would select directories, data files, and executable files, as well as other system resources, based on the recorded time attributes of such resources.

### SUMMARY OF THE INVENTION

The present invention has been developed in response to the present state of the art, and in particular, in response to the problems and needs in the art that have not yet been met for associating resources using a time based algorithm. Accordingly, the present invention has been developed to provide an apparatus, system, and method for associating resources using a time based algorithm that overcomes many or all of the above-discussed shortcomings in the art.

An apparatus according to the present invention includes an initialization module, a query module, and a resource time module. The initialization module receives a seed identifier that identifies a seed resource, such as an executable file. Certain operations involving the seed resource are recorded in trace data that describes a plurality of resource events.

In one embodiment, the initialization module may receive a seed identifier from a user, such as a system administrator via a user interface, or from a client application. The seed identifier may comprise the name of an executable file or a data file.

The query module is configured to search the trace data for a candidate resource that might be associated with the seed resource, such as in a logical application or business process. In certain embodiments, the query module may search for all resource events involving the seed resource and attributes of the seed resource. In other embodiments, the query module may search for only those resource events and attributes that involve the seed resource and a particular event type, such as a creation or modification operation.

The resource time module, in one embodiment, is configured to select a candidate resource based on a time attribute that is similar between the seed resource and the candidate resource. For example, the similar time attribute may be defined by a creation or access time attribute of a system resource that is comparably within a time range surrounding a corresponding creation or access time of the seed resource or another linked resource. In a further embodiment, the resource time module is also configured to link or associate the candidate resource with the seed resource. For example, the resource time module may create or update a resource group record that includes the seed identifier and one or more resource identifiers by way of the newly linked resource.

In certain embodiments, the query module and the resource time module may be employed either sequentially or iteratively to identify and select candidate resources. For example, after the resource time module links the candidate resource to the seed resource, the query module may subsequently use the newly linked resource to search for additional candidate resources that may be directly or indirectly associated with the original seed resource.

The resource time module, in one embodiment, may comprise a creation time module and an access time module. The creation time module may further comprise a creation time range module, a creation comparison module, and a creation removal module. The access time module may further comprise an access time range module, an access comparison module, and an access removal module.

The creation time module determines if a system resource is likely to be associated with the seed resource based on the time that the seed resource is created and the time that the system resource is created. In addition, the creation time of a linked resource may be used in place of the creation time of the seed resource. A creation time refers to the time at which a resource is created. In one embodiment, a creation time also may refer to the time at which a copy of a resource is made, in which case the creation time refers to the creation time of the copy, but not necessarily of the original resource.

The creation time range module allows a time range to be set that is inclusive of the creation time of the linked resource. The creation comparison module determines if the creation time of the system resource is within the limits of the creation time range. If so, the system resource may be selected as a candidate resource and linked to the seed resource. Under certain circumstances, linked resources may be removed from a resource group record, or otherwise dissociated from the seed resource, via the creation removal module.

The access time module determines if a system resource is likely to be associated with the seed resource based on the time that the seed resource is accessed and the time that the system resource is accessed. Alternatively, the access time of a linked resource may be used in place of the access time of the seed resource. An access time refers to the time at which a resource is started (such as an executable file), modified (such as a data file), or otherwise invoked within a computing operation.

The access time range module allows a time range to be set that is inclusive of the access time of the linked resource. The access comparison module determines if the access time of the system resource is within the limits of the access time range. If so, the system resource may be selected as a candidate resource and linked to the seed resource. Under certain circumstances, linked resources may be removed from a resource group record, or otherwise dissociated from the seed resource, via the access removal module.

A method of the present invention is also presented for associating resources using a time based algorithm. In one embodiment, the method includes receiving a seed identifier corresponding to a seed resource, searching the trace data for a candidate resource, and selecting the candidate resource based on a common time attribute involving the seed resource and the candidate resource. In further embodiments, the method also may include linking the candidate resource with the seed resource to form a resource group, selecting a candidate resource based on a similar creation time, and selecting a candidate resource based on a similar access time. Still further, the method may include dissociating a candidate resource from a seed resource, if necessary, and relating the resource group to a logical application or business process.

The present invention also includes embodiments arranged as a system, machine-readable instructions, and an apparatus that comprise substantially the same functionality as the components and steps described above in relation to the apparatus and method. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one example of how a business level policy may be conventionally implemented;

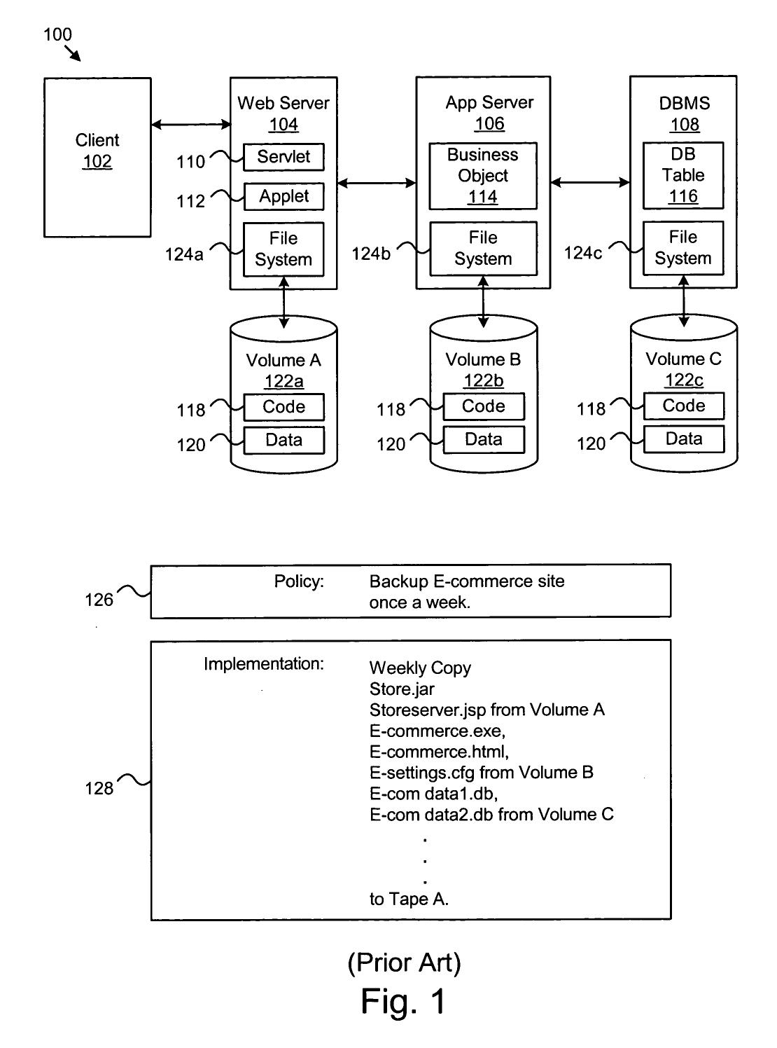

FIG. 2 is a logical block diagram illustrating one embodiment of an apparatus that automatically discovers and groups resources used by a logical application;

FIG. 3 is a schematic block diagram illustrating in detail sub-components of the apparatus of FIG. 2;

FIG. 4 is a schematic block diagram illustrating an example of a relational analysis apparatus of one embodiment of the present invention;

FIG. 5 is a schematic block diagram illustrating a resource timing tree in accordance with the present invention;

FIG. 6 is a schematic block diagram of a resource group record according to one embodiment the present invention;

FIG. 7 is a schematic flow chart diagram illustrating one embodiment of a creation comparison method in accordance with the present invention;

FIG. 8 is a schematic flow chart diagram illustrating one embodiment of a creation removal method in accordance with the present invention;

FIG. 9 is a schematic flow chart diagram illustrating one embodiment of an access comparison method in accordance with the present invention; and

FIG. 10 is a schematic flow chart diagram illustrating one embodiment of an access removal method in accordance with the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the apparatus, system, and method of the present invention, as presented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

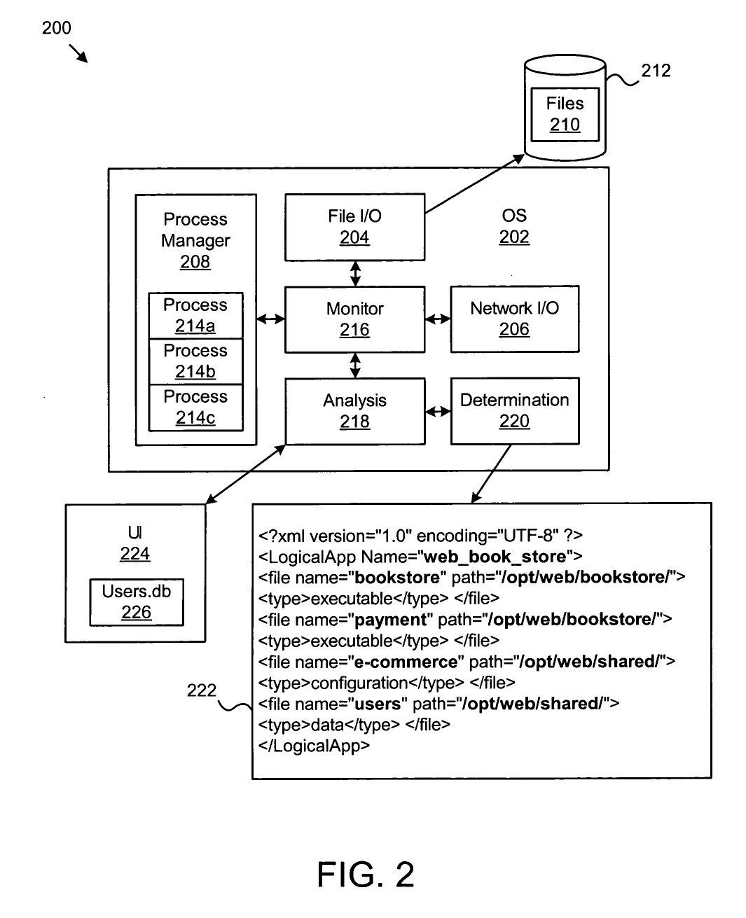

FIG. 2 illustrates a logical block diagram of an apparatus 200 configured to automatically discover and group files used by a logical application which may also correspond to a business process. A business process may be executed by a wide array of hardware and software components configured to cooperate to provide the desired business services (i.e., email services, retail web storefront, inventory management, etc.). For clarity, certain well-known hardware and software components are omitted from FIG. 2.

The apparatus 200 may include an operating system 202 that provides general computing services through a file I/O module 204, network I/O module 206, and process manager 208. The file I/O module 204 manages low-level reading and writing of data to and from files 210 stored on a storage device 212, such as a hard drive. Of course, the storage device 212 may also comprise a storage subsystem such as various types of DASD systems. The network module 206 manages network communications between processes 214 executing on the apparatus 200 and external computer systems accessible via a network (not shown). Preferably, the file I/O module 204 and network module 206 are modules provided by the operating system 202 for use by all processes 214a-c. Alternatively, custom file I/O module 204 and network modules 206 may be written where an operating system 202 does not provide these modules.

The operating system 202 includes a process manager 208 that schedules use of one or more processors (not shown) by the processes 214a-c. The process manager 208 includes certain information about the executing processes 214a-c. In one embodiment, the information includes a process ID, a process name, a process owner (the user that initiated the process), process relation (how a process relates to other executing processes, i.e., child, parent, sibling), other resources in use (open files or network ports), and the like.

Typically, the business process is defined by one or more currently executing processes 214a-c. Each process 214 includes either an executable file 210 or a parent process which initially creates the process 214. Information provided by the process manager 208 enables identification of the original files 210 for the executing processes 214a-c, discussed in more detail below.

In certain embodiments, the apparatus 200 includes a monitoring module 216, analysis module 218, and determination module 220. These modules 216, 218, 220 cooperate to dynamically identify the resources that comprise a logical application that corresponds to the business process. Typically, these resources are files 210. Alternatively, the resources may be other software resources (servers, daemons, etc.) identifiable by a network address such as a URL or IP address.

In this manner, operations can be performed on the files 210 and other resources of a logical application (business process) without the tedious, labor intensive, error prone process of manually identifying these resources. These operations include implementing business level policies such as policies for backup, recovery, server load management, migration, and the like.

The monitoring module 216 communicates with the process manager 208, file I/O module 204, and network I/O module 206 to collect trace data. The trace data is any data indicative of operational behavior of a software application (as used herein “application” refers to a single process and “logical application” refers to a collection of one or more processes that together implement a business process). Trace data may be identifiable both during execution of a software application or after initial execution of a software application. Certain trace data may also be identifiable after the initial installation of a software application. For example, software applications referred to as installation programs can create trace data simply by creating new files in a specific directory.

Preferably, the monitoring module 216 collects trace data for all processes 214a-c. In one embodiment, the monitoring module 216 collects trace data based on an identifier (discussed in more detail below) known to directly relate to a resource implementing the business process. Alternatively, the monitoring module 216 may collect trace data for all the resources of an apparatus 200 without distinguishing based on an identifier.

In one embodiment, the monitoring module 216 communicates with the process manager 208 to collect trace data relating to processes 214 currently executing. The trace data collected represents processes 214a-c executing at a specific point in time. Because the set of executing processes 214a-c can change relatively frequently, the monitoring module 216 may periodically collect trace data from the process manager 208. Preferably, a user-configurable setting determines when the monitoring module 216 collects trace data from the process manager 208.

The monitoring module 216 also communicates with the file I/O module 204 and network module 206 to collect trace data. The file I/O module 204 maintains information about file access operations including reads, writes, and updates. From the file I/O module, the monitoring module 216 collects trace data relating to current execution of processes 214 as well as historical operation of processes 214.

Trace data collected from the file I/O module 204 may include information such as file name, file directory structure, file size, file owner/creator, file access rights, file creation date, file modification date, file type, file access timestamp, what type of file operation was performed (read, write, update), and the like. In one embodiment, the monitoring module 216 may also determine which files 210 are currently open by executing processes 214. In certain embodiments, the monitoring module 216 collects trace data from a file I/O module 204 for one or more file systems across a plurality of storage devices 212.

As mentioned above, the monitoring module 216 may collect trace data for all files 210 of a file system or only files and directories clearly related to an identifier. The identifier and/or resources presently included in a logical application may be used to determine which trace data is collected from a file system.

The monitoring module 216 collects trace data from the network I/O module 206 relating to network activity by the processes 214a-c. Certain network activity may be clearly related to specific processes 214 and/or files 210. Preferably, the network I/O module 206 provides trace data that associates one or more processes 214 with specific network activity. A process 214 conducting network activity is identified, and the resource that initiated the process 214 is thereby also identified.

Trace data from the network I/O module 206 may indicate which process 214 has opened specific ports for conducting network communications. The monitoring module 216 may collect trace data for well-known ports which are used by processes 214 to perform standard network communications. The trace data may identify the port number and the process 214 that opened the port. Often only a single, unique process uses a particular network port.

For example, communications over port eighty may be used to identify a web server on the apparatus 200. From the trace data, the web server process and executable file may be identified. Other well-known ports include twenty for FTP data, twenty-one for FTP control messages, twenty-three for telnet, fifty-three for a Domain Name Server, one hundred and ten for POP3 email, etc.

In certain operating systems 202, such as UNIX and LINUX, network I/O trace data is stored in a separate directory. In other operating systems 202 the trace data is collected using services or daemons executing in the background managing the network ports.

In one embodiment, the monitoring module 216 autonomously communicates with the process manager 208, file I/O module 204, and network I/O module 206 to collect trace data. As mentioned, the monitoring module 216 may collect different types of trace data according to different user-configurable periodic cycles. When not collecting trace data, the monitoring module 216 may “sleep” as an executing process until the time comes to resume trace data collection. Alternatively, the monitoring module 216 may execute in response to a user command or command from another process.

The monitoring module 216 collects and preferably formats the trace data into a common format. In one embodiment, the format is in one or more XML files. The trace data may be stored on the storage device 212 or sent to a central repository such as a database for subsequent review.

The analysis module 218 analyzes the trace data to discover resources that are affiliated with a business process. Because the trace data is collected according to operations of software components implementing the business process, the trace data directly or indirectly identifies resources required to perform the services of the business process. By identifying the resources that comprise a business process, business management policies can be implemented for the business process as a whole. In this way, business policies are much simpler to implement and more cost effective.

In one embodiment, the analysis module 218 applies a plurality of heuristic routines to determine which resources are most likely associated with a particular logical application and the business process represented by the logical application. The heuristic routines are discussed in more detail below. Certain heuristic routines establish an association between a resource and the logical application with more certainty than others. In one embodiment, a user may adjust the confidence level used to determine whether a candidate resource is included within the logical application. This confidence level may be adjusted for each heuristic routine individually and/or for the analysis module 218 as a whole.

The analysis module 218 provides the discovered resources to a determination module 220 which defines a logical application comprising the discovered resources. Preferably, the determination module 220 defines a structure 222 such as a list, table, software object, database, a text eXtended Markup Language (XML) file, or the like for recording associations between discovered resources and a particular logical application. As mentioned above, a logical application is a collection of resources required to implement all aspects of a particular business process.

The structure 222 includes a name for the logical application and a listing of all the discovered resources. Preferably, sufficient attributes about each discovered resource are included such that business policies can be implemented with the resources. Attributes such as the name, location, and type of resource are provided.

In addition, the structure 222 may include a frequency rating indicative of how often the resource is employed by the business process. In certain business processes this frequency rating may be indicative of the importance of the resource. In addition, a confidence value determined by the analysis module 218 may be stored for each resource.

The confidence level may indicate how likely the analysis module 218 has determined that this resource is properly associated with the given logical application. In one embodiment, this confidence level is represented by a probability percentage. For certain resources, the structure 222 may include information such as a URL or server name that includes resources used by the business process but not directly accessible to the analysis module 218.

Preferably, the analysis module 218 cooperates with the determination module 220 to define a logical application based on an identifier for the business process. In this manner, the analysis module 218 can use the identifier to filter the trace data to a set more likely to include resources directly related to a business process of interest. Alternatively, the analysis module 218 may employ certain routines or algorithms to propose certain logical applications based on clear evidence of relatedness from the trace data as a whole without a pre-defined identifier.

A user interface (UI) 224 may be provided so that a user can provide the identifier to the analysis module 218. The identifier 226 may comprise one of several types of identifiers including a file name for an executable or data file, file name or process ID for an executing process, a port number, a directory, and the like. The resource identified by the identifier 226 may be considered a seed resource for the logical application, as the resource identified by the identifier 226 is included in the logical application by default and is used to add additional resources discovered by searching the trace data.

For example, a user may desire to create a logical application according to which processes accessed the data base file “Users.db.” In the UI 224, the user enters the file name users.db. The analysis module 218 then searches the trace data for processes that opened or closed the users.db file. Heuristic routines are applied to any candidate resources identified, and the result set of resources is presented to the user in the UI 224.

The result set includes the same information as in the structure 222. The UI 224 may also allow the user to modify the contents of the logical application by adding or removing certain resources. The user may then store a revised logical application in a human readable XML structure 222. In addition, the user may adjust confidence levels for the heuristic routines and the analysis module 218 overall.

In this manner, the apparatus 200 allows for creation of logical applications which correspond to business processes. The logical applications track information about resources that implement the business process to a sufficient level of detail that business level policies, such as backup, recovery, migration, and the like, may be easily implemented. Furthermore, logical application definitions can be readily adjusted and adapted as subsystems implementing a business process are upgraded, replaced, and modified. The logical application tracks business data as well as the processes/executables that operate on that business data. In this manner, business data is fully archivable for later use without costly conversion and data extraction procedures.

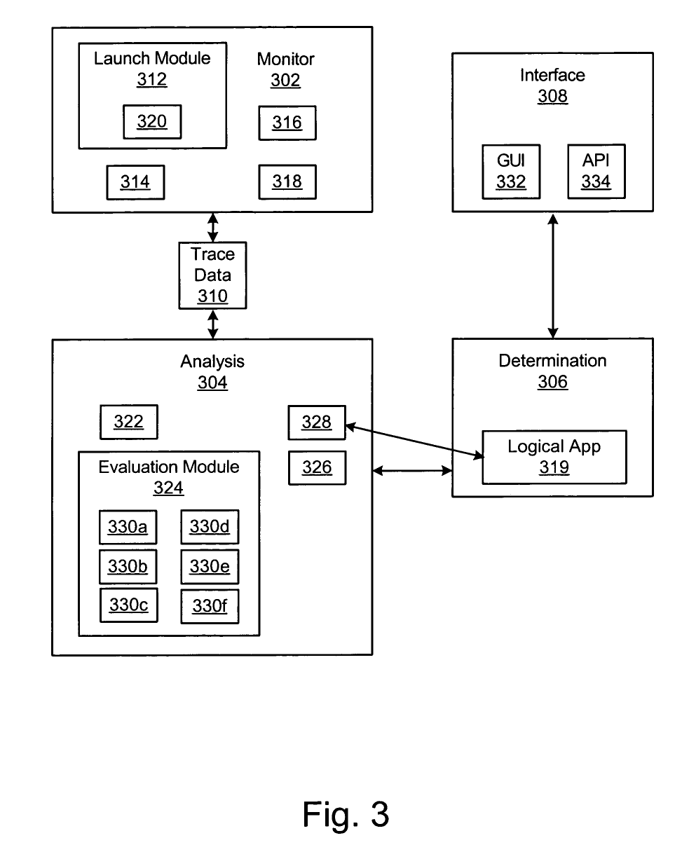

FIG. 3 illustrates more details of one embodiment of the present invention. This embodiment is similar to the apparatus 200 illustrated in FIG. 2. Specifically, the illustrated embodiment includes a monitoring module 302, analysis module 304, determination module 306, and interface 308.

In one embodiment, the monitoring module 302 collects trace data 310 as a business process is executing. In other words, the monitoring module 302 collects trace data as applications implementing the business process are executing. However, the monitoring module 302 may also collect sufficient trace data 310 when a business process is not being executed/operated. In addition, the interface 308 may receive an identifier that directly relates a resource implementing a business process to the business process. Preferably, the identifier is unique to the business process, although uniqueness may not always be required. This identifier may be used by the analysis module 304 in analyzing the trace data 310.

The monitoring module 302 includes a launch module 312, a controller 314, a storage module 316, and a scanner 318. The launch module 312 initiates one or more activity monitors 320. The launch module 312 may launch activity monitors 320 when the monitoring module 302 starts or periodically according to monitoring schedules defined for each activity monitor 320 or for the monitoring module 302 as a whole.

An activity monitor 320 is a software function, thread, or application, configured to trace a specific type of activity relating to a resource. The activity monitor may gather the trace data by monitoring the activity directly or indirectly by gathering trace data from other modules such as the process manager 208, file I/O module 204, and network I/O module 206 described in relation to FIG. 2.

In one embodiment, each activity monitor 320 collects trace data for a specific type of activity. For example, a file I/O activity monitor 320 may communicate with a file I/O module 204 and capture all file I/O operations as well as contextual information, such as which process made the file I/O request, what type of request was made and when. One example of an activity monitor 320 that may be used with the present invention is a file filter module described in U.S. patent application Ser. No. 10/681,557, filed on Oct. 7, 2003, entitled “Method, System, and Program for Processing a File Request,” hereby incorporated by reference. Of course, various other types of activity monitors may be initiated depending on the nature of the activities performed by the business process. Certain activity monitors may trace Remote Procedure Calls (RPC).

The controller 314 controls the operation of the activity monitors 320 in one embodiment. The controller 314 may adjust the priorities for scheduling of the activity monitors to use a monitored system's processor(s). In this manner, the controller 314 allows monitoring to continue and the impact of monitoring to be dynamically adjusted as needed. The control and affect of the controller 314 on overall system performance is preferably user configurable.

The storage module 316 interacts with the activity monitors 320 to collect and store the trace data collected by each individual activity monitor 320. In certain embodiments, when an activity monitor 320 detects a resource (executable file, data file, or software module) conducting a specific type of activity, the activity monitor 320 provides the activity specific trace data to the storage module 316 for storage.

The storage module 316 may perform certain general formatting and organization to the trace data before storing the trace data. Preferably, trace data for all the activity monitors 320 is stored in a central repository such as a database or a log/trace file.

Typically, activity monitors 320 monitor dynamic activities performed during operation of a business process while the scanner 318 collects trace data from relatively static system information such as file system information, processes information, networking information, I/O information, and the like. The scanner 318 scans the system information for a specific type of activity performed by the business process.

For example, the scanner 318 may scan one or more file system directories for files created/owned by a particular resource. The resource may be named by the identifier such that it is known that this resource belongs to the logical application 319 that implements the business process. Consequently, the scanner 318 may provide any trace data found to the storage module 316 for storage.

In one embodiment, the monitoring module 302 produces a set or batch of trace data 310 that the analysis module 304 examines at a later time (batch mode). Alternatively, the monitoring module 302 may provide a stream of trace data 310 to the analysis module 304 which analyzes the trace data 310 as the trace data 310 is provided (streaming mode). Both modes are considered within the scope of the present invention.

The analysis module 304 may include a query module 322, an evaluation module 324, a discovery module 326, and a modification module 328. The evaluation module 324 and discovery module 326 work closely together to identify candidate resources to be associated with a logical application 319.

The evaluation module 324 applies one or more heuristic routines 330a-f to a set of trace data 310. Preferably, the query module 322 filters the trace data 310 to a smaller result set. Alternatively, the heuristic routines 330a-f are applied to all available trace data 310.

The filter may comprise an identifier directly associated with a business process. The identifier may be a resource name such as a file name. Alternatively, the filter may be based on time, activity, type, or other suitable criteria to reduce the size of the trace data 310. The filter may be generic or based on specific requirements of a particular heuristic routine 330a-f.

In one embodiment, the evaluation module 324 applies the heuristic routines 330a-f based on an identifier. The identifier provides a starting point for conducting the analysis of trace data. In one embodiment, an identifier known to be associated with the business process is automatically associated with the corresponding logical application 319. The identifier is a seed for determining which other resources are also associated with the logical application 319. The identifier may be a file name for a key executable file known to be involved in a particular business process.

Each heuristic routine 330a-f analyzes the trace data based on the identifier or a characteristic of a software application represented by the identifier. For example, the characteristic may comprise the fact that this software application always conducts network I/O over port 80. An example identifier may be the inventorystartup.exe which is the first application started when an inventory control system is initiated.

A heuristic routine 330a-fis an algorithm that examines trace data 310 in relation to an identifier and determines whether a resource found in the trace data 310 should be associated with a logical application. This determination is very complex and difficult because the single identifier provides such little information about the logical application 319. Consequently, heuristics are applied to provide as accurate of a determination as possible.

As used herein, the term “heuristic” means “a technique designed to solve a problem that ignores whether the solution is probably correct, but which usually produces a good solution or solves a simpler problem that contains or intersects with the solution of the more complex problem.” (See definition on the website www wikipedia org.).

In a preferred embodiment, an initial set of heuristic routines 330a-f is provided, and a user is permitted to add his/her own heuristic routines 330a-f. The heuristic routines 330a-f cooperate with the discovery module 326. Once a heuristic routine 330a-f identifies a resource associated with the logical application, the discovery module 326 discovers the resources and creates the association of the resource to the logical application.

One heuristic routine 330a identifies all resources that are used by child applications of the application identified by the identifier. Another heuristic routine 330b identifies all resources in the same directory as a resource identified by the identifier. Another heuristic routine 330c analyzes usage behavior of a directory and parent directories that store the resource identified by the identifier to identify whether the sub or parent directories and all their contents are associated with the logical application.

One heuristic routine 330d determines whether the resource identified by the identifier belongs to an installation package, and if so, all resources in the installation package are deemed to satisfy the heuristic routine 330d. Another heuristic routine 330e examines resources used in a time window centered on the start time for execution of a resource identified by the identifier. Resources used within the time window satisfy the heuristic routine 330e. Finally, one heuristic routine 330f may be satisfied by resources which meet user-defined rules. These rules may include or exclude certain resources based on site-specific procedures that exist at a computer facility.

In one embodiment, the evaluation module 324 cooperates with the discovery module 326 to discover resources according to two distinct methodologies. The first methodology is referred to as a build-up scheme. Under this methodology, the heuristic routines 330a-f are applied to augment the set of resources currently within a set defining the logical application. In this manner, the initial resource identified by the identifier, the seed, grows into a network of associated resources as the heuristic routines 330a-f are applied. Use of this scheme represents confidence that the heuristic routines will not miss relevant resources, but runs the risk that some resources may be missed. However, this scheme may exclude unnecessary resources.

The second methodology, referred to as the whittle-down scheme, is more conservative but may include resources that are not actually associated with the logical application. The whittle-down scheme begins with a logical application comprising a pre-defined superset representing all resources that are accessible to the computer system(s) implementing the logical application, business process. The heuristic routines 330a-f are then applied using an inverse operation, meaning resources that satisfy a heuristic routine 330a-f are removed from the pre-defined superset.

Regardless of the methodology used, the evaluation module 324 produces a set of candidate resources which are communicated to the modification module 328. The modification module 328 communicates the candidate resources to the determination module 306 which adds or removes the candidate resources from the set defined in the logical application 319. The determination module 306 defines and re-defines the logical application 319 as indicated by the modification module 328.

Preferably, the evaluation module 324 is configured to apply the heuristic routines 330a-f for each resource presently included in the logical application 319. Consequently, the modification module 328 may also determine whether to re-run the evaluation module 324 against the logical application 319. In one embodiment, the F-modification module 328 may make such a determination based on a user-configurable percentage of change in the logical application 319 between running iterations of the evaluation module 324. Alternatively, a user-configurable setting may determine a pre-defined number of iterations.

In this manner, the logical application 319 continues to grow or shrink based on relationships between recently added resources and resources already present in the logical application 319. Once the logical application 319 changes very little between iterations, the logical application may be said to be stable.

Once the modification module 328 determines that the logical application 319 is complete (stable or the required number of iterations have been completed), the determination module 306 provides the logical application 319 to the interface 308. Preferably, the interface 308 allows a user to interact with the logical application 319 using either a Graphical User Interface 332 (GUI) or an Application Programming Interface 334 (API).

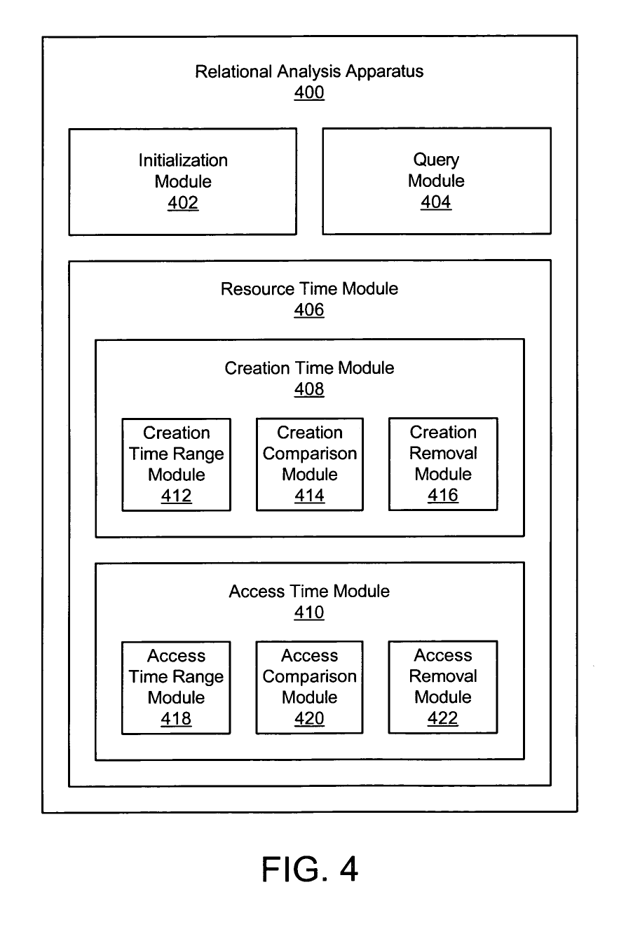

FIG. 4 depicts one embodiment of a relational analysis apparatus 400 given by way of example of the analysis module 304 of FIG. 3. The illustrated relational analysis apparatus 400 includes an initialization module 402, a query module 404, and a resource time module 406. While the relational analysis apparatus 400 may be employed to facilitate defining a logical application associated with a business process, certain embodiments of the present invention may be employed independently of a business process in order to establish an association between a seed identifier and one or more other system resources.

The initialization module 402, in one embodiment, is configured to receive a seed identifier, which identifies a seed resource, as described above. The query module 404, in one embodiment, is substantially similar to the query module 322 described in relation to FIG. 3. Among other functions, the query module 404 is configured to search the trace data 310 for system resources that may be related to the seed resource. In one embodiment, the query module 404 may search all of the trace data 310. Alternatively, the query module 404 may search only a subset of the trace data 310.

The resource time module 406 includes a creation time module 408 and an access time module 410. In one embodiment, the creation time module 408 includes a creation time range module 412, a creation comparison module 414, and a creation removal module 416. Similarly, the access time module 410 may include an access time range module 418, an access comparison module 420, and an access removal module 422.

In one embodiment, the resource time module 406 is configured to select a candidate resource. A “candidate resource” is a system resource that is determined to possibly be associated with the seed resource based on a common time attribute involving the seed resource and the candidate resource. In particular, a “common time attribute” (also referred to as a “similar time attribute”) includes any common timestamp or other time indicator recorded in the trace data 310 that is relatively similar between the seed resource and an executable file, a data file, a directory, or any other system resource.

For example, when the seed resource is an executable file, a most-recent-start timestamp may be assigned to the seed resource to designate when the seed resource was last started. Similarly, when a data file, for example, is accessed by an executable file, a last-access timestamp may be assigned to the data file to designate when the data file was last accessed. As used herein, “access” may refer to creation of a resource, modification of a resource, deletion of a resource, or any other resource event that involves a certain resource. For example, accessing a data file within a directory may cause a last-access timestamp to be assigned to the data file, as well as a last-access timestamp to be assigned to the directory in which the data file resides. In this case and with regard to the description herein, the directory is considered “accessed” when a file within the directory is created, modified, deleted, and so forth. Such access operations are recorded in the trace data 310, as described above.

The creation time module 408 is configured, in one embodiment, to determine if a system resource is likely to be associated with the seed resource based on the time that the seed resource was created and the time that the system resource was created. The creation times of the seed resource and the system resource may be recorded in corresponding creation timestamps for each resource. Alternatively, a creation time may be inferred from an earliest access timestamp.

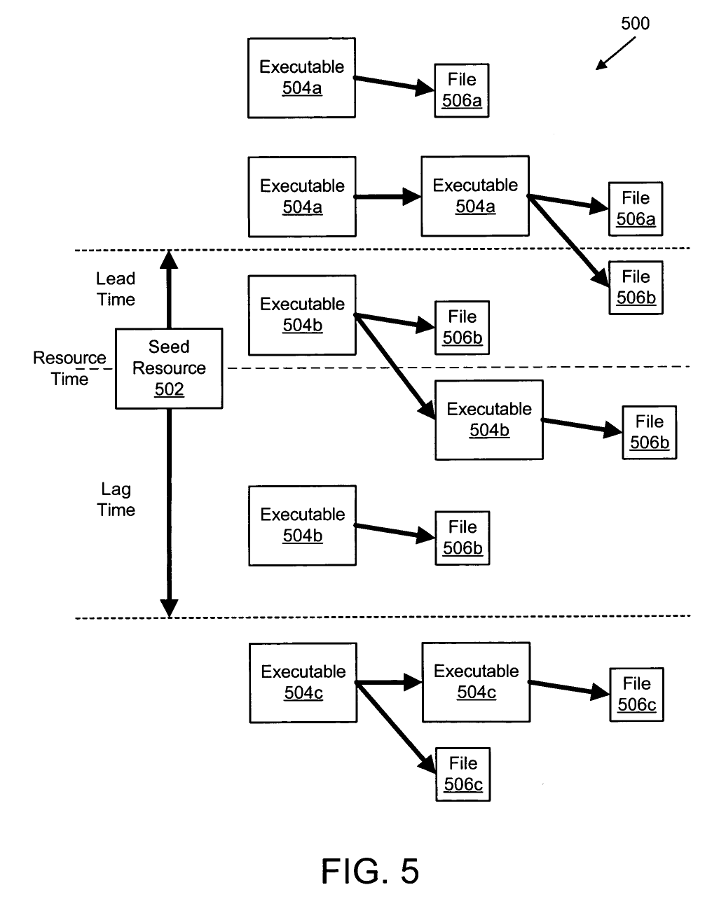

In one embodiment, the creation time module 408 may employ the creation time range module 412 to allow a user to input a creation time range to specify how closely in time the creation timestamp of the system resource must be to the creation timestamp of the seed resource. The creation time range may include a lead time and a lag time. The lead time specifies a window duration prior to the creation timestamp of the seed resource. Likewise, the lag time specifies a window duration subsequent to the creation timestamp of the seed resource. FIG. 5 offers a graphical illustration that is used to describe a time range in more detail.

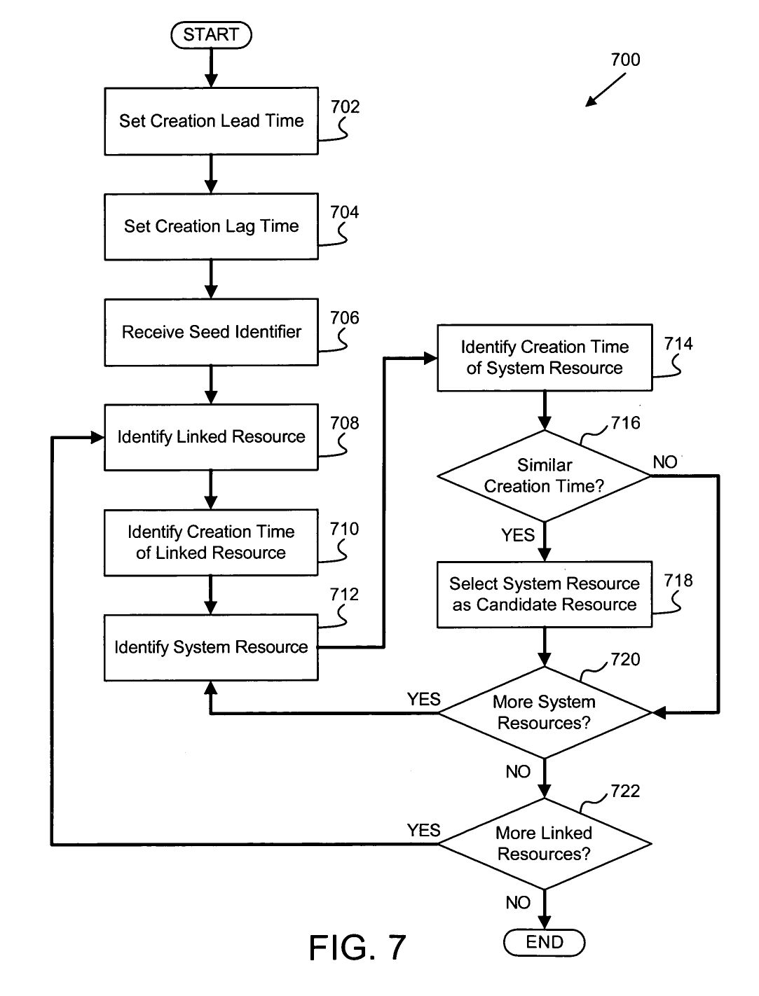

The creation time range module 412 also may be used to retrieve, access, or modify a previously stored creation time range. The creation comparison module 414 may be employed to determine if the creation timestamp of a system resource is within the creation time range for a particular seed resource. The functionality and features of the creation comparison module 414 are described in further detail with reference to FIG. 7.

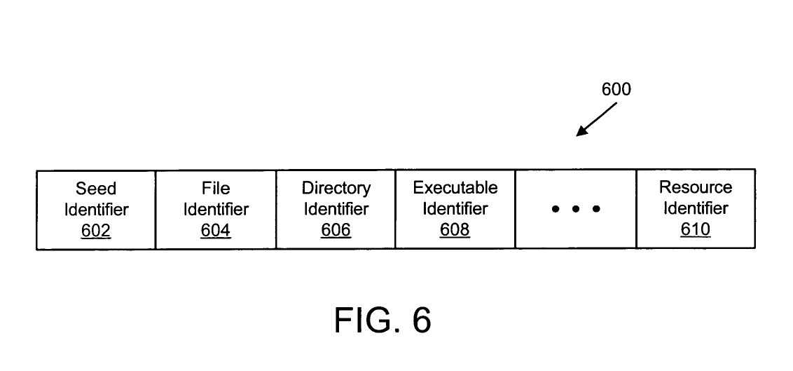

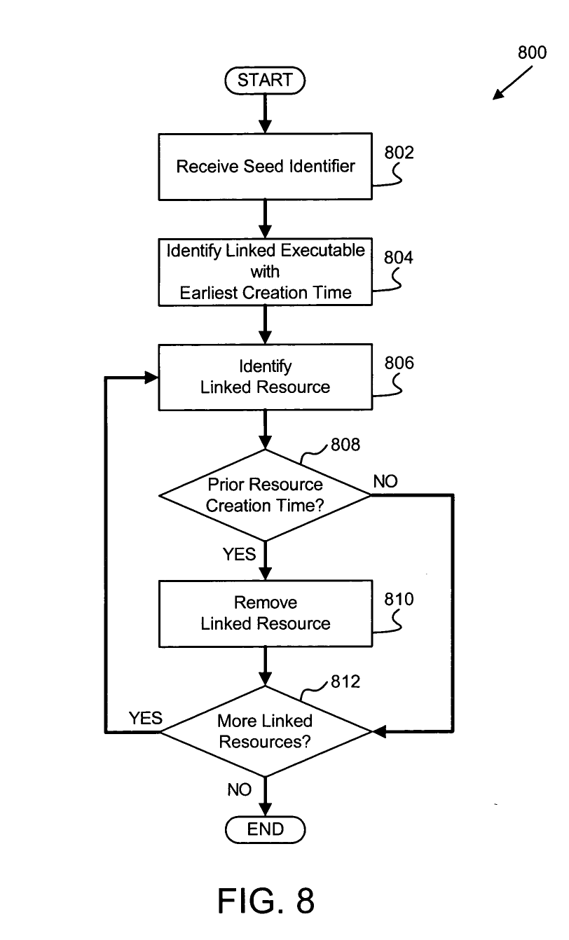

If the creation timestamp is similar to the creation time range (within the lead time and lag time of the creation time range) of the seed resource, the system resource may be recorded in a resource group record (also referred to as “linked”). One embodiment of a resource group record is described in more detail with reference to FIG. 6. Under certain circumstances, the creation time module 408 may employ the creation removal module 416 to remove a system resource from the resource group record, thereby eliminating any prior link between the system resource and the seed resource. The functionality and features of the creation removal module 416 are described in further detail with reference to FIG. 8.

The access time module 410 is configured, in one embodiment, to determine if a system resource is likely to be associated with the seed resource based on the time that the seed resource is accessed and the time that the system resource is accessed. The access times of the seed resource and the system resource may be recorded in corresponding access timestamps for each resource. The access time module 410 is substantially similar to the creation time module 408, except that the access time module 410 is concerned with the access time, rather than the creation time, of the seed and system resources.

In one embodiment, the access time module 410 may employ the access time range module 418 to allow a user to input an access time range to specify how closely in time the access timestamp of the system resource must be to the access timestamp of the seed resource. The access time range may include a lead time and a lag time, similar to the creation lead and lag time described above. FIG. 5 offers a graphical illustration that is used to describe a time range in more detail.

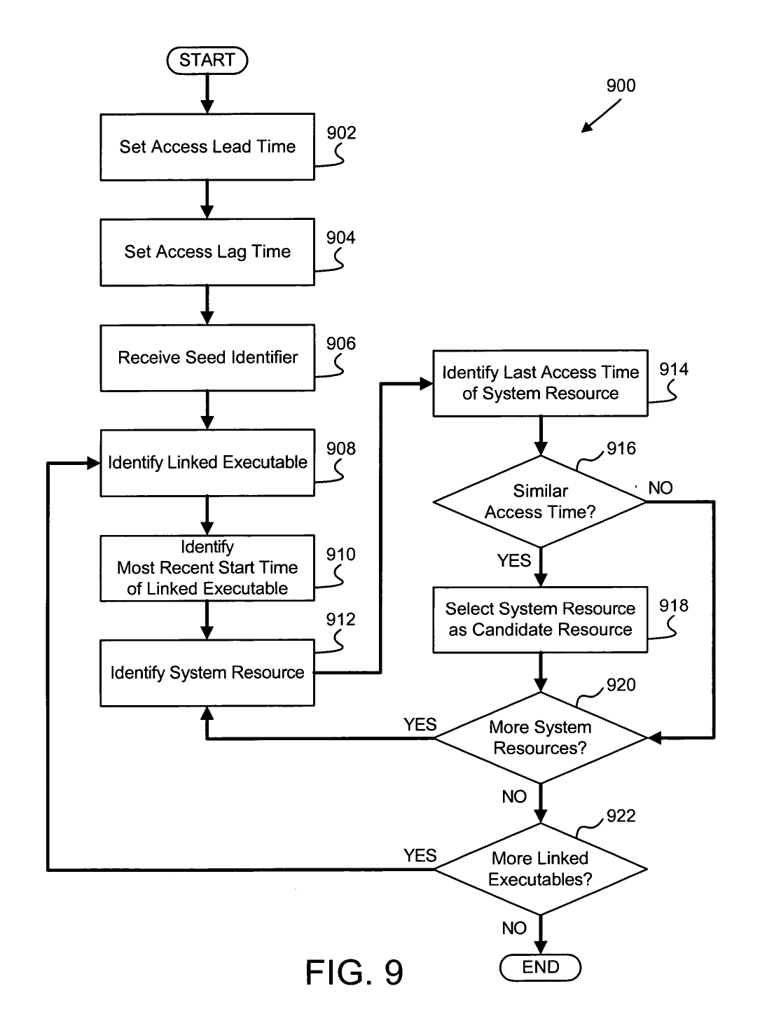

The access time range module 418 also may be used to retrieve, access, or modify a previously stored access time range. The access comparison module 420 may be employed to determine if the access timestamp of a system resource is within the access time range associated with a particular seed resource. The functionality and features of the access comparison module 420 are described in further detail with reference to FIG. 9.

If the access timestamp is similar to the access time range (within the lead time and lag time of the access time range) of the seed resource, the system resource may be linked to the seed resource in a resource group record. Under certain circumstances, the access time module 410 may employ the access removal module 422 to remove a system resource from the resource group record, thereby eliminating any prior link

The access time module 410 is configured, in one embodiment, to determine if a system resource is likely to be associated with the seed resource based on the time that the seed resource is accessed and the time that the system resource is accessed. The access times of the seed resource and the system resource may be recorded in corresponding access timestamps for each resource. The access time module 410 is substantially similar to the creation time module 408, except that the access time module 410 is concerned with the access time, rather than the creation time, of the seed and system resources.

In one embodiment, the access time module 410 may employ the access time range module 418 to allow a user to input an access time range to specify how closely in time the access timestamp of the system resource must be to the access timestamp of the seed resource. The access time range may include a lead time and a lag time, similar to the creation lead and lag time described above. FIG. 5 offers a graphical illustration that is used to describe a time range in more detail.

The access time range module 418 also may be used to retrieve, access, or modify a previously stored access time range. The access comparison module 420 may be employed to determine if the access timestamp of a system resource is within the access time range associated with a particular seed resource. The functionality and features of the access comparison module 420 are described in further detail with reference to FIG. 9.

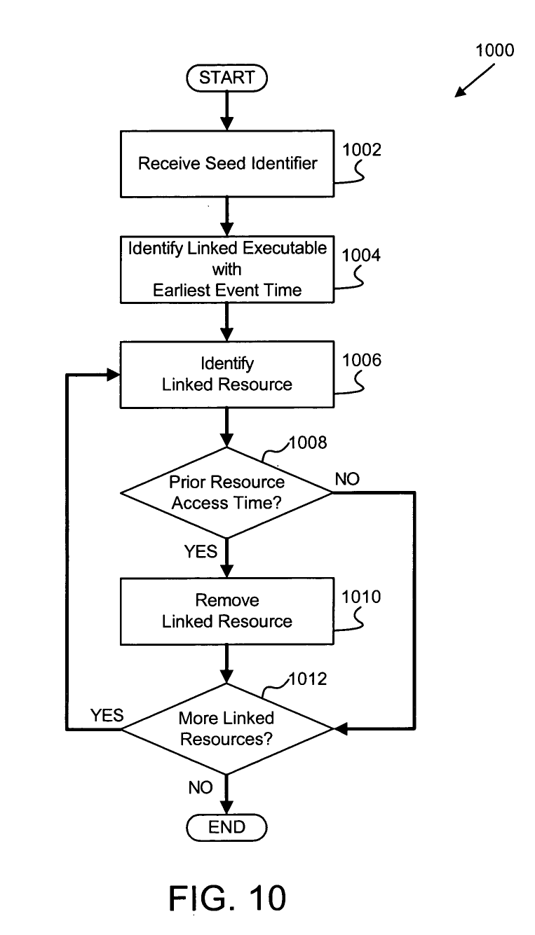

If the access timestamp is similar to the access time range (within the lead time and lag time of the access time range) of the seed resource, the system resource may be linked to the seed resource in a resource group record. Under certain circumstances, the access time module 410 may employ the access removal module 422 to remove a system resource from the resource group record, thereby eliminating any prior link between the system resource and the seed resource. The functionality and features of the access removal module 422 are described in further detail with reference to FIG. 10.

FIG. 5 depicts a resource timing tree 500 that illustrates the several timing relationships described with reference to the creation time module 408 and the access time module 410 of FIG. 4. For clarity in describing the several resource relationships illustrated in the resource timing tree 500, the present description employs the terms “executable” and “file,” in which “executable” refers to an executable file and “file” may refer to an executable file, a data file, or any other system resource that might be accessed by the “executable.” This terminology is only employed for descriptive purposes to show timing and access relationships between the several system resources (directories, data files, and executable files, etc.) and is not meant to limit other implementations or relationships that might be recognized in various systems and scenarios.

The illustrated resource timing tree 500 centers around a seed resource 502, which may be an executable file, a data file, a directory, or another system resource. The seed resource 502 may be associated with several other system resources based on the time attributes of the seed resource 502 and the other system resources. Specifically, the seed resource 502 has a resource time (represented by the large, horizontal, dashed line). In one embodiment, the resource time may be the creation time of the seed resource 502. Alternatively or additionally, the resource time may be an access time, such as a modification, most-recent-start, or last-save time of the seed resource 502. In one embodiment, the creation and access times for the seed resource 502 may be derived from the trace data 310. Alternately, these times may be stored in a resource group record, as described below.

A time range is defined by identifying a lead time and a lag time (represented by the small, horizontal, dashed lines above and below the resource time). As depicted, the top of the page corresponds to a time earlier than the resource time and the bottom of the page corresponds to a time after the resource time. The lead time and lag time may be equal, in one embodiment, or may be distinct from one another. In the depicted embodiment, the lag time is greater than the lead time, but other embodiments of the invention allow for various other time range configurations.

FIG. 5 illustrates a number of executables 504 and files 506 that are accessed, created, or otherwise involved in a resource event at some time in relation to the time range depicted. Some of the executables 504a and files 506a are accessed prior to the lead time of the time range. Other executables 504b and files 506b are accessed during the time range (after the lead time and before the lag time). Still other executables 504c and files 506c are accessed subsequent to the lag time of the time range. Each time one of these executables 504 or files 506 is created, a creation timestamp may be associated with the created resources. Similarly, each time one of these executables or files 506 is otherwise accessed, an access timestamp may be associated with the accessed resources.

For example, an executable 504 may have a most-recent-start timestamp and a file 506 may have a last-access timestamp. These timestamps may be derived, in one embodiment, from the trace data 310. Alternately, these times may be stored in metadata related to a specific resource or resource event. Additionally, these times may be computed by the creation time module 408 or the access time module 410 of the resource time module 406.

Referring to FIG. 5 and to the creation time module 408 of FIG. 4, the creation time module 408 may create a resource group record that identifies the seed resource 502 and all of the executables 504b and files 506b that are created during the creation time range. Details for creating such a resource group record based on the creation time of the resources 502-506 is described in more detail with reference to FIG. 7.

Referring to FIG. 5 and to the access time module 410 of FIG. 4, the access time module 410 may create a resource group record that identifies the seed resource 502 and all of the executables 504b and files 506b that are accessed during the access time range. Details for creating such a resource group record based on the access time of the resources 502-506 is described in more detail with reference to FIG. 9.

FIG. 6 depicts one embodiment of a resource group record 600 that may be used to identify a resource group. As described above, a “resource group” is a set of system resources that are determined to be associated with a given seed resource. In one embodiment, resource groups may define a single software application. Alternatively or in addition, a resource group may be used to define a logical application related to a business process. The illustrated resource group record 600 includes a seed identifier 502, a data file identifier 604, a directory identifier 606, an executable file identifier 608, and one or more additional resource identifiers 610.

The seed identifier 602 identifies the seed resource. The data file identifier 604 identifies a data file associated with the seed resource. Likewise, the directory identifier 606 identifies a directory associated with the seed resource. Similarly, the executable file identifier 608 identifies an executable file associated with the seed resource. Finally, the additional resource identifiers 610 identify other resources, including additional data files, executable files, directories, memory cards, dongles, etc., that are associated with the seed resource. Although many different types of resources are shown associated with the seed resource in the illustrated resource group record 600, a particular resource group may comprise fewer or more types of system resources and a corresponding resource group record 600 may comprise fewer or more types of system resource identifiers 604-610.

FIG. 7 depicts one embodiment of a creation comparison method 700 that may be employed by the creation time module 408 of the resource time module 406 of FIG. 4. The illustrated creation comparison method 700 begins by setting 702 a creation lead time and setting 704 a creation lag time. In this way, a user or an application client may set the creation time range. In one embodiment, a user may employ the creation time range module 412 to set 702, 704 the lead and lag times. Alternately, the lead and lag times may be set to default settings. For example, the lead time may be set by default to 5 seconds and the lag time may be set by default to 15 seconds, unless set otherwise by the user.

The initialization module 402 subsequently receives 706 a seed identifier 602 that identifies a seed resource 502. As described above, the seed resource 502 may be a data file, an executable file, a directory, or another system resource. In an alternate embodiment, the initialization module 402 may receive 706 the seed identifier 602 prior to setting 702, 704 the lead and lag times for the creation time range. In fact, the creation time range may be dependent, in one embodiment, on the seed resource 502 identified by the seed identifier 602. For example, the time range may be based on a resource type, in one embodiment, or set to a default in the absence of a user override.

The resource time module 406 then identifies 708 a linked resource that is associated with the seed resource 502. As used herein the seed resource 502 also may be considered a linked resource because the seed resource 502 is implicitly linked to itself. In one embodiment, the linked resource may be identified 708 by accessing a resource group record 600 that includes the seed identifier 602. The creation time module 408 then identifies 710 the creation time of the linked resource. In one embodiment, the creation time for a resource is a known attribute of the linked resource, such as in the form of a creation timestamp stored in the resource group record 600.

The query module 404 then identifies 712 a system resource from the recorded trace data 310, which is described above with reference to FIG. 3. In one embodiment, the trace data 310 records the creation time and access times of the executables 504 and files 506 described with reference to the resource timing chart 500 of FIG. 5. The creation time module 408 then identifies 714 the creation time of the system resource. In one embodiment, the creation time of the system resource is derived from the trace data 310. Alternately, the creation time may be stored in metadata associated with the system resource.

The creation comparison module 414 subsequently compares the creation time of the system resource to the creation time range defined by the lead time and lag time set 702, 704 previously. The creation comparison module 414 determines 716 if the creation time of the system resource is similar to the creation time of the linked resource. In one embodiment, the creation times are determined 716 to be “similar” if it is within a defined creation time range.

If the creation comparison module 414 determines 716 that the creation time of the system resource is similar to the creation time of the linked resource, the creation time module 408 selects 718 the system resource as a candidate resource. A candidate resource may be linked to the seed resource by adding a resource identifier 610 for the candidate resource to the corresponding resource group record 600. Otherwise, if the creation times are determined to not be similar, the system resource is not selected 718 as a candidate resource.

The query module 404 then determines 720 if the trace data 310 contains time attributes for additional system resources and, if so, returns to identify 712 a subsequent system resource and repeat the steps described above. Otherwise, the resource time module 406 may determine 722 if additional linked resources are identified in the corresponding resource group record 600 and, if so, returns to identify 708 a subsequent linked resource and repeat the steps described above. In one embodiment, the resource time module 406 may identify 708 a newly linked system resource for use in subsequent iterations. Once the trace data 310 has been traversed for each of the linked resources, the creation comparison method 700 then ends.

It is possible that, after several iterations of the creation comparison method 700 of FIG. 7, certain resources created prior to an executable file resource may have been added to a resource group record 600. However, these resources may not share any other association with the other resources of the resource group. For example, none of the executable resources in the resource group may actually access these earlier created resources. Consequently, the method 700 may have added false positives to the resource group record 600.

Certain false positives can be removed from the resource group record 600 using a linked executable file resource with the earliest creation time among all the executable files in the resource group record 600. For example, by identifying an earliest created linked executable file, there is a high likelihood that all of the linked data files and/or directories with creation times prior to the creation time of the earliest created linked executable file may be removed from the resource group record 600 and thereby dissociated from the seed resource 502. The creation time of the earliest created linked executable file may be referred to herein as a first-creation time.

FIG. 8 depicts one embodiment of a creation removal method 800 that may be used to remove a linked resource from a resource group record 600. The illustrated creation removal method 800 begins as the initialization module 402 receives 802 a seed identifier 602. Alternately, the seed identifier 602 may be the same as the seed identifier 602 received 706 during the creation comparison method 700 of FIG. 7. In one embodiment, the creation time module 408 then identifies 804 one linked executable file having the earliest creation time of all of the linked executable files. The creation time of this earliest-created executable file may be designated as the first-creation time. The creation comparison module 414 then identifies 806 one of the linked resources in the resource group record 600 and determines 808 if the creation time of the linked resource is prior to the first-creation time, corresponding to the earliest-created executable file. If so, the creation removal module 416 may remove 810 the linked resource from the resource group record 600. In this way, the previously linked resource is no longer linked to the seed resource 502. False positives are removed from the resource group.

The creation comparison module 414 subsequently determines 812 if additional linked resources need to be compared to the first-creation time and, if so, returns to identify 806 a subsequent linked resource. Otherwise, after the creation time for each linked resource has been compared to the first-creation time, corresponding to the earliest-created executable file, the creation removal method 800 then ends.

FIG. 9 depicts one embodiment of an access comparison method 900 that may be employed by the access time module 410 of the resource time module 406 of FIG. 4. In certain embodiments, the access comparison method 900 is substantially similar to the creation comparison method 700 of FIG. 700. However, the access comparison method 900 is configured to select candidate resources based on similar access times rather than creation times. For example, a last-access time for a data file may be similar to a most-recent-start time for a linked executable file.

The illustrated access comparison method 900 begins by setting 902 an access lead time and setting 904 an access lag time. In this way, a user or an application client may set the access time range. In one embodiment, a user may employ the access time range module 418 to set 902, 904 the lead and lag times. Alternately, the lead and lag times may be set to default settings, as described above.

The initialization module 402 subsequently receives 906 a seed identifier 602 that identifies a seed resource 502. As described above, the seed resource 502 may be a data file, an executable file, a directory, or another system resource. In an alternate embodiment, the initialization module 402 may receive 906 the seed identifier 602 prior to setting 902, 904 the lead and lag times for the access time range. In fact, the access time range may be dependent, in one embodiment, on the seed resource 502 identified by the seed identifier 602. For example, the time range may be based on a resource type, in one embodiment, or set to a default in the absence of a user override.

The resource time module 406 then identifies 908 a linked resource that is associated with the seed resource 502. As used herein the seed resource 502 also may be considered a linked resource because the seed resource 502 is implicitly linked to itself. In one embodiment, the linked resource may be a linked executable file and may be identified 908 by accessing a resource group record 600 that includes the seed identifier 602. The access time module 410 then identifies 910 the most-recent-start time of the linked executable file. In one embodiment, the most-recent-start time is a known attribute of the linked executable file, such as in the form of a most-recent-start timestamp, and stored in the resource group record 600. Alternately, the most-recent-start time may be computed based on a comparison of the current time to all of the start times for that executable file, as recorded in the trace data 310.

The query module 404 then identifies 912 a system resource from the recorded trace data 310, which is described above with reference to FIG. 3. As mentioned previously, the trace data 310 records the access times of the file and directory accesses by the executables 504 and files 506 described with reference to the resource timing chart 500 of FIG. 5. The access time module 410 then identifies 914 the last-access time of the system resource. In one embodiment, the last-access time of the system resource is derived from the trace data 310. Alternately, the last-access time may be stored in metadata associated with the system resource.

The access comparison module 420 subsequently compares the last-access time of the system resource to the access time range defined by the lead time before and the lag time after the most-recent-start time of the linked executable file. The access comparison module 420 determines 916 if the last-access time of the system resource is similar to the most-recent-start time of the linked executable file. In one embodiment, the last-access and most-recent-start times are determined 916 to be “similar” if the last-access time is within a defined most-recent-start time range.

If the access comparison module 414 determines 916 that the last-access time of the system resource is similar to the most-recent-start time of the linked executable file, the access time module 408 selects 918 the system resource as a candidate resource. As described above, a candidate resource may be linked to the seed resource by adding a resource identifier 610 for the candidate resource to the corresponding resource group record 600. Otherwise, if the access times (last-access and most-recent-start) are determined to not be similar, the system resource is not selected 918 as a candidate resource.

The query module 404 then determines 920 if the trace data 310 contains time attributes for additional system resources and, if so, returns to identify 912 a subsequent system resource and repeat the steps described above. Otherwise, the resource time module 406 may determine 922 if additional linked resources are identified in the corresponding resource group record 600 and, if so, returns to identify 908 a subsequent linked resource and repeat the steps described above. In one embodiment, the resource time module 406 may identify 908 a newly linked system resource for use in subsequent iterations. Once the trace data 310 has been traversed for each of the linked resources, the access comparison method 900 then ends.

It is possible that, after several iterations of the access comparison method 900 of FIG. 9, certain resources accessed prior to an executable file resource may have been added to a resource group record 600. However, these resources may not share any other association with the other resources of the resource group. For example, none of the executable resources in the resource group may actually access these earlier created resources. Consequently, the method 900 may have added false positives to the resource group record 600.

Certain false positives can be removed from the resource group record 600 using a linked executable file resource with the earliest access time among all the executable files in the resource group record 600. For example, by identifying an earliest accessed linked executable file, there is a high likelihood that all of the linked data files and/or directories with access times prior to the access time of the earliest accessed linked executable file may be removed from the resource group record 600 and thereby dissociated from the seed resource 502. The access time of the earliest accessed linked executable file may be referred to herein as a first-access time.

FIG. 10 depicts one embodiment of an access removal method 1000 that may be used to remove a linked resource from a resource group record 600. The illustrated access removal method 1000 begins as the initialization module 402 receives 1002 a seed identifier 602. Alternately, the seed identifier 602 may be the same as the seed identifier 602 received 906 during the access comparison method 900 of FIG. 9. In one embodiment, the access time module 410 then identifies 1004 one linked executable file having the earliest most-recent-start time of all of the linked executable files. The most-recent-start time of this earliest-accessed executable file may be designated as the first-access time. The access comparison module 420 then identifies 1006 one of the linked resources in the resource group record 600 and determines 1008 if the access time of the linked resource is prior to the first-access time, corresponding to the earliest-accessed executable file. If so, the access removal module 422 may remove 1010 the linked resource from the resource group record 600. In this way, the previously linked resource is no longer linked to the seed resource 502. False positives are removed from the resource group.

The access comparison module 420 subsequently determines 1012 if additional linked resources need to be compared to the first-access time and, if so, returns to identify 1006 a subsequent linked resource. Otherwise, after the access time for each linked resource has been compared to the first-access time, corresponding to the earliest-accessed executable file, the access removal method 1000 then ends.

Advantageously, the present invention in various embodiments facilitates automatically associating system resources, given a seed resource identifier and trace data describing a plurality of resource events and time attributes. The present invention beneficially also uses time based algorithms to recognize certain relationships between the seed resource and one or more other resources.

In further embodiments, the present invention may be employed to either build up or whittle down a resource group. As explained above, building up a resource group allows only system resources that are known to be related to a seed resource to be added to the resource group. This results in a resource group in which all linked resources are confidently associated with the seed resource. The algorithms, modules, and methods described herein are conducive to a build-up scheme.

In contrast, whittling down a resource group includes all system resources except those known to be unrelated to the seed resource. This results in a more inclusive, but less confident, association between the linked resources and the seed resource. An inverse variation of the algorithms, modules, and methods described herein would be conducive to a whittle-down scheme.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to associate resources using a time based algorithm, the apparatus comprising:
an initialization module configured to receive a seed identifier corresponding to a seed resource, the seed resource comprising one of a plurality of system resources;
a query module configured to search trace data for a candidate resource, the trace data descriptive of a plurality of resource events among the plurality of system resources; and
a resource time module configured to select the candidate resource based on a similar time attribute involving the seed resource and the candidate resource.

2. The apparatus of claim 1, wherein the resource time module is further configured to link the candidate resource with the seed resource and to create a resource group, the resource group comprising the seed resource and the linked resource.

3. The apparatus of claim 1, wherein the resource time module further comprises a creation time module configured to select the candidate resource based on a similar creation time attribute shared by the candidate resource and the seed resource.

4. The apparatus of claim 3, wherein the creation time module comprises a creation time range module configured to define a time range inclusive of a creation time attribute of the seed resource, the time range comprising a creation lead time and a creation lag time.

5. The apparatus of claim 3, wherein the creation time module comprises a creation comparison module configured to compare a creation time attribute of the candidate resource to a creation time attribute of the seed resource.

6. The apparatus of claim 5, wherein the creation comparison module is further configured to determine if the creation time attribute of the candidate resource is within a time range inclusive of the creation time of the seed resource.

7. The apparatus of claim 3, wherein the creation time module comprises a creation removal module configured to dissociate the candidate resource from the seed resource in response to a determination that a creation time attribute of the candidate resource precedes a creation time attribute of an earliest-created linked executable file.

8. The apparatus of claim 1, wherein the resource time module further comprises an access time module configured to select the candidate resource based on a similar access time attribute of the candidate resource and the seed resource.

9. The apparatus of claim 8, wherein the access time module comprises an access time range module configured to define an access time range inclusive of a most-recent-start time attribute of the seed resource, the time range comprising an access lead time and an access lag time.

10. The apparatus of claim 8, wherein the access time module comprises an access comparison module configured to compare a last-access time attribute of the candidate resource to a most-recent-start time attribute of the seed resource.

11. The apparatus of claim 10, wherein the access comparison module is further configured to determine if the last-access time attribute of the candidate resource is within an access time range inclusive of the most-recent-start time attribute of the seed resource.

12. The apparatus of claim 8, wherein the access time module comprises an access removal module configured to dissociate the candidate resource from the seed resource in response to a determination that a last-access time attribute of the candidate resource precedes a most-recent-start time attribute of an earliest-started linked resource.

13. A system to associate resources using a time based algorithm, the system comprising:
a monitor module configured to monitor a plurality of resource events among a plurality of system resources;
a storage device configured to store trace data, the trace data descriptive of the plurality of resource events;
an initialization module configured to receive a seed identifier from a user, the seed identifier corresponding to a seed resource, the seed resource comprising one of the plurality of system resources;
a query module configured to search the trace data for a candidate resource; and
a resource time module configured to select the candidate resource based on a similar time attribute involving the seed resource and the candidate resource.

14. The system of claim 13, wherein the resource time module is further configured to link the candidate resource with the seed resource.

15. The system of claim 13, further comprising a creation time module configured to assign the candidate resource to a business process based on a similar creation time attribute of the candidate resource and the seed resource.

16. The system of claim 13, further comprising an access time module configured to assign the resource candidate to a business process based on a similar access time of the candidate resource and the seed resource.

17. A signal bearing medium tangibly embodying a program of machine-readable instructions executable by a digital processing apparatus to perform operations to associate resources using a time based algorithm, the operations comprising:
receiving a seed identifier corresponding to a seed resource, the seed resource comprising one of a plurality of system resources;
searching trace data for a candidate resource, the trace data descriptive of a plurality of resource events among the plurality of system resources; and
selecting the candidate resource based on a similar time attribute involving the seed resource and the candidate resource.

18. The signal bearing medium of claim 17, wherein the instructions further comprise operations to link the candidate resource with the seed resource and create a resource group, the resource group comprising the seed resource and the linked resource.

19. The signal bearing medium of claim 17, wherein the similar time attribute comprises a creation time attribute shared by the candidate resource and the seed resource.

20. The signal bearing medium of claim 19, wherein the instructions further comprise operations to compare a creation time attribute of the candidate resource to a creation time attribute of the seed resource.

21. The signal bearing medium of claim 19, wherein the instructions further comprise operations to determine if the creation time attribute of the candidate resource is within a time range inclusive of the creation time attribute of the seed resource, the time range comprising a creation lead time and a creation lag time.

22. The signal bearing medium of claim 19, wherein the instructions further comprise operations to dissociate the candidate resource from the seed resource in response to a determination that a creation time attribute of the candidate resource precedes a creation time attribute of an earliest-created linked executable file.

23. The signal bearing medium of claim 17, wherein the similar time attribute comprises an access time attribute of the candidate resource and the seed resource, the access time attribute comprising a most-recent-start time attribute of the seed resource and a last-access time attribute of the candidate resource.

24. The signal bearing medium of claim 23, wherein the instructions further comprise operations to compare the last-access time attribute of the candidate resource to the most-recent-start time attribute of the seed resource.

25. The signal bearing medium of claim 23, wherein the instructions further comprise operations to determine if the last-access time attribute of the candidate resource is within an access time range inclusive of the most-recent-start time attribute of the seed resource, the time range comprising an access lead time and an access lag time.

26. The signal bearing medium of claim 23, wherein the instructions further comprise operations to dissociate the candidate resource from the seed resource in response to a determination that a last-access time attribute of the candidate resource precedes a most-recent-start time attribute of an earliest-started linked resource.

27. A method for associating resources using a time based algorithm, the method comprising:
receiving a seed identifier corresponding to a seed resource, the seed resource comprising one of a plurality of system resources;
searching trace data for a candidate resource, the trace data descriptive of a plurality of resource events among the plurality of system resources; and
selecting the candidate resource based on a similar time attribute involving the seed resource and the candidate resource.

28. An apparatus to associate resources using a time based algorithm, the apparatus comprising:
means for receiving a seed identifier corresponding to a seed resource, the seed resource comprising one of a plurality of system resources;
means for searching trace data for a candidate resource, the trace data descriptive of a plurality of resource events among the plurality of system resources; and
means for selecting the candidate resource based on a similar time attribute involving the seed resource and the candidate resource.
